(19) United States
(12) Patent Application Publication
(10) Pub. No.: US 2008/0129534 A1
(43) Pub. Date: Jun. 5, 2008

(54) Method and Device for Localizing Anomalies Located Inside a Hollow Structure Located on Bare Ground and/or Buried

(75) Inventors: Thierry Blanche, Suresnes (FR); Robert Charles, Antony (FR); Jean-Yves Satre, Chevreuse (FR)

Correspondence Address: BROWDY AND NEIMARK, P.L.L.C.;624 NINTH STREET, NW, SUITE 300, WASHINGTON, DC, 20001-5303, US

(73) Assignee: Enertag, Meudon La Foret (FR)

(21) Appl. No.: 11/814,376

(22) PCT Filed: Jan. 18, 2006
(86) PCT No.: PCT/FR06/00143

§ 371 Date: Jul. 20, 2007

(30) Foreign Application Priority Data
Jan. 20, 2005 (FR) 05 00589

(51) Int. Cl. H04B 13/02; G01V 15/00

(52) U.S. Cl. 340/854.1

(57) ABSTRACT

The invention relates to a method of externally locating anomalies inside a hollow structure which is positioned on and/or below the ground (PL), wherein said anomalies have been previously detected by a device (R_{TE}) moving inside the hollow structure and positioned by counting a series of reference marks from an origin, said reference marks being located at regular intervals and being accessible from the inside and outside of the hollow structure (PL). The inventive method comprises the following steps consisting in: a. defining by means of courting a reference mark, starting from said origin, which is accessible from outside of the hollow structure; b. positioning a transponder module (T) on said reference mark; c. identifying the transponder module (T) by an I.D. code; and d. determining the number of reference marks separating the anomalies and the identified transponder module (T).

The present invention relates to a method and device for localizing anomalies located inside a hollow structure located on bare ground and/or buried.

This method is notably applied, but not exclusively, to the maintenance of rigid or flexible pipelines with which oils or gases may be transferred between production sites and storage or distribution sites, located on bare ground and/or buried.

Generally, it is known that a pipeline consists of a metal casing, made from sections of steel tube, and of an outer shield made in concrete.

The sections have a length close to 12 meters and an outer diameter generally between 12 inches and 36 inches; they are connected together by a weld.

The concrete coating, with which the metal casing may be protected, has a thickness close to 2-5 centimeters.

The welding of the metal sections and the concrete casing coating are achieved by equipment close to the laying site; said equipment lays the pipeline in a continuous way on the ground or in a trench, according to a path defined beforehand and controlled by an absolute value positioning system.

Moreover, the pipelines may be laid in a non-rectilinear way, for reasons related to the nature of the land; the ground is not necessarily horizontal; other pipelines may be present and may form obstacles to be bypassed or overridden.

The identification of each of the pipelines, indispensable for providing their maintenance, is achieved via passive components, such as plates either numbered or with different collars.

The passive devices generally are rapidly ilreadable, making their identification difficult or even impossible.

Moreover it is known that maintenance of pipelines is preceded by a visual and sometimes radiographic inspection of the metal casing via a robot moving inside the pipeline.

The latter may thus detect anomalies, such as corrosion of the metal of the casing, degradation of a weld connecting two sections, deformation of the metal casing caused by an accidental displacement of the pipeline. These pieces of information may be stored in the actual robot, or transmitted in real time to a control station, via an umbilical cord.

Localization of the possible anomalies is carried out via welds between sections, thereby forming by counting from an origin, the reference system associated with the relevant pipeline.

Thus, localization of an anomaly reported by the observation robot at weld n, or of an anomaly reported between weld n and weld n+1, may be carried out externally, in a second phase, by identical counting from the same origin, of the welds, given the fact that the latter are indirectly apparent because of the nature of the concrete coating carried out at said welds.

These operations for internal inspection of the pipelines are costly, considering the applied means and moreover generate immobilization costs of said means as well as operating losses related to momentarily stopping production.

Localization of possible anomalies should therefore be accurate and without any risks of error.

The identification means, mentioned earlier, only partly meet the striven goals.

More particularly, the object of the invention is to remove these drawbacks.

It proposes carrying out external localization of anomalies located in a hollow structure, which anomalies having been detected beforehand by a device moving inside said hollow structure laid on bare ground and/or buried, and positioned by counting from an origin, marks located at regular intervals accessible from the inside and from the outside of said hollow structure, consisting of:
defining by counting, from the same aforesaid origin, a mark accessible from outside the hollow structure,
positioning a transponder module on the aforesaid mark,
identifying the transponder module by an identification code,
determining the number of marks separating said anomalies and said identified transponder module.

Thus, the counting from an origin generally defined as being the aperture for accessing the pipeline, of the number of marks such as the welds connecting together the different sections, which are directly visible from the inside of the metal casing, and indirectly on the outside of the pipeline, forms a reference system associated with the relevant pipeline.

Of course, this reference system relatively to the pipeline is not an absolute value positioning reference system of said pipeline. Other means must be applied with which the topographic relationship may be defined between this reference system relative to the pipeline and the absolute value positioning system accessible from ground-level.

In a more specific way, the identification of the reference system relative to the pipeline, formed by marks accessible from the inside and the outside, which in this case are welds connecting the sections, is carried out via transponders, which comprise an identification code.

Thus, in proximity to all the n welds (n being equal to or larger than 1), transponders will be mechanically firmly attached to the pipeline, each of said transponders including at least one identification code specific to the pipeline and to the weld associated with the corresponding transponder.

With a low power device for reading from a distance the transponder comprising receiving means coupled with a receiving antenna in order to remotely sense the signal emitted by the transponder when it is placed in proximity to the latter, and means for processing the received signal and providing the information corresponding to the received signal, it will be possible to identify the weld associated with said transponder, without any risks of error.

By these arrangements, counting of the welds performed during the phase for internal observation of the pipeline allowing a possible anomaly to be positioned, associated with the external identification of the welds carried out by reading the identification code of the corresponding transponder, will allow said anomaly observed from the inside, to be localized externally.

Of course, the possible observed external anomalies will be localized in the same way by means of the external identification of the welds, which is carried out by reading the identification code of the corresponding transponder.

According to a particularity of the invention, the reading device may comprise means for storing information corresponding to the received signal and means for remotely transmitting the read identification code to a receiving station comprising a computer terminal.

According to another particularity of the invention, the reading device may comprise means for writing information in a writable and readable memory of the transponder, concerning, as an example, the characteristics of the maintenance intervention, the operational conditions under which the maintenance operations were carried out.

Reading and writing information into the writable and readable memory of the transponder may be carried out in situ on bare ground or in a buried medium, but also beforehand at the surface before placing said transponder in the trench; in this case, data defining the initial conditions specific to the relevant buried structure are written into the memory of the transponder.

Advantageously, the frequencies utilized for reading and writing information into the writable and readable memory of the transponder will be those which are for example standardized to this day for free propagation in air, i.e., 125 kHz and 134.2 kHz or any other frequency, preferably lower than the latter. As for the powers generated by the reading and writing device, they will be between 1 W and 100 W, preferably between 4 W and 20 W.

As an example, the operating characteristics may be the following:

Frequency: less than 125 kHz; power: 20 W; reading and writing distance separating the reading and writing device from the transponder: 150 cm.

Advantageously, the methods for firmly attaching the transponder to the buried hollow structure in situ may be adhesive bonding, the use of straps or the use of open collars; during mounting in the factory, the firm attachment methods will essentially be of the peg type, either fixed or embedded into the coating of the hollow structure, made in concrete or resin.

An embodiment of the method according to the invention will be described hereafter as a non-limiting example, with reference to the appended drawings wherein:

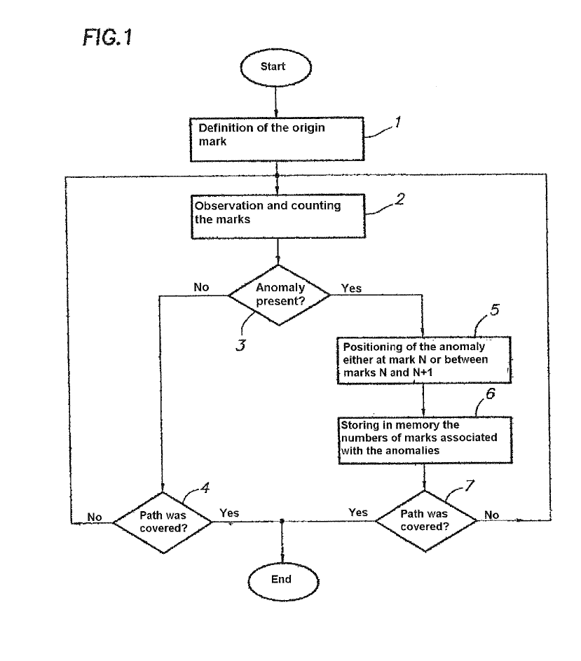

FIG. 1 illustrates a flowchart for localizing anomalies inside a hollow structure,

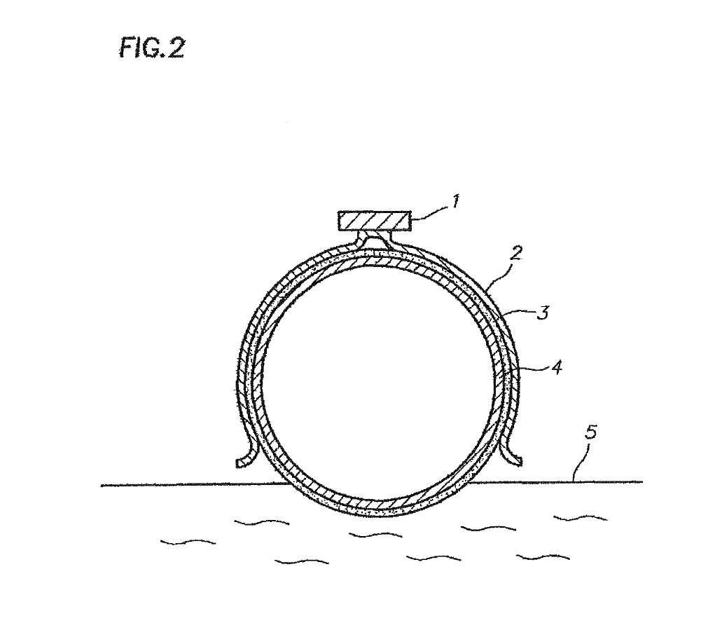

FIG. 2 illustrates a schematic view of a first means for firmly attaching the transponder,

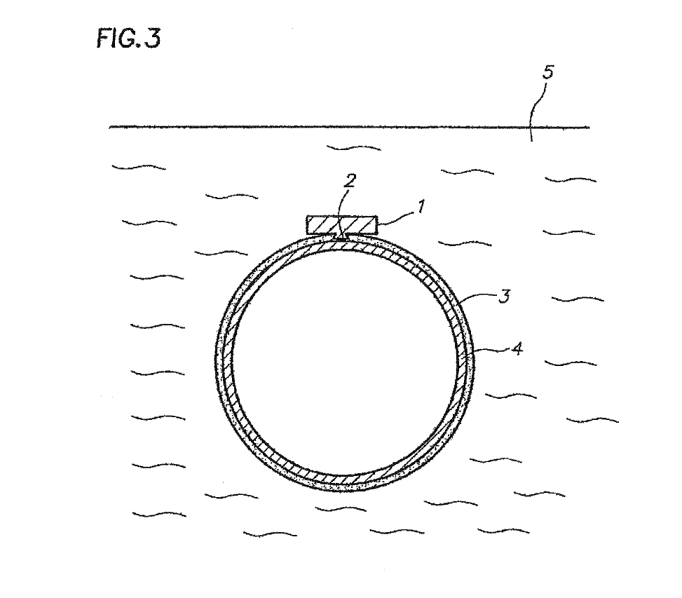

FIG. 3 illustrates a schematic view of a second means for firmly attaching the transponder,

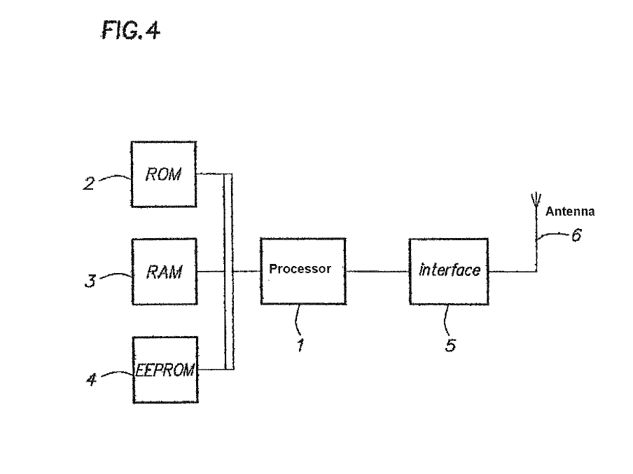

FIG. 4 illustrates a block diagram of an exemplary architecture of a transponder,

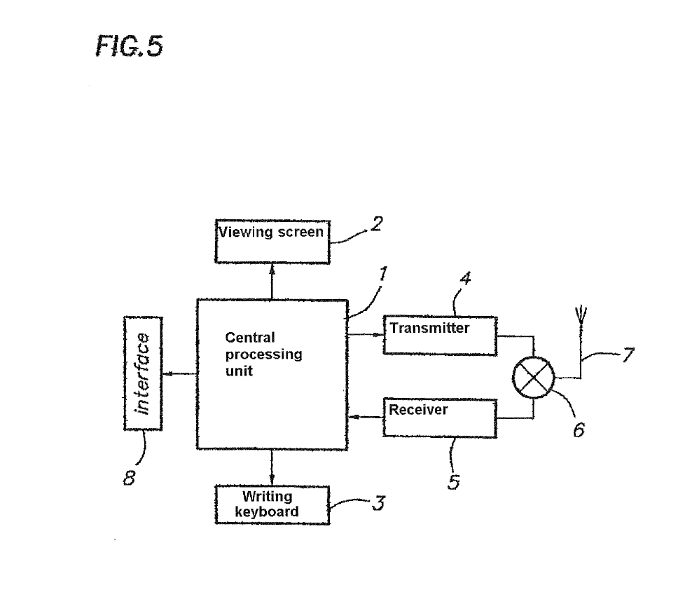

FIG. 5 illustrates a block diagram of an exemplary architecture of a reading and writing device, and

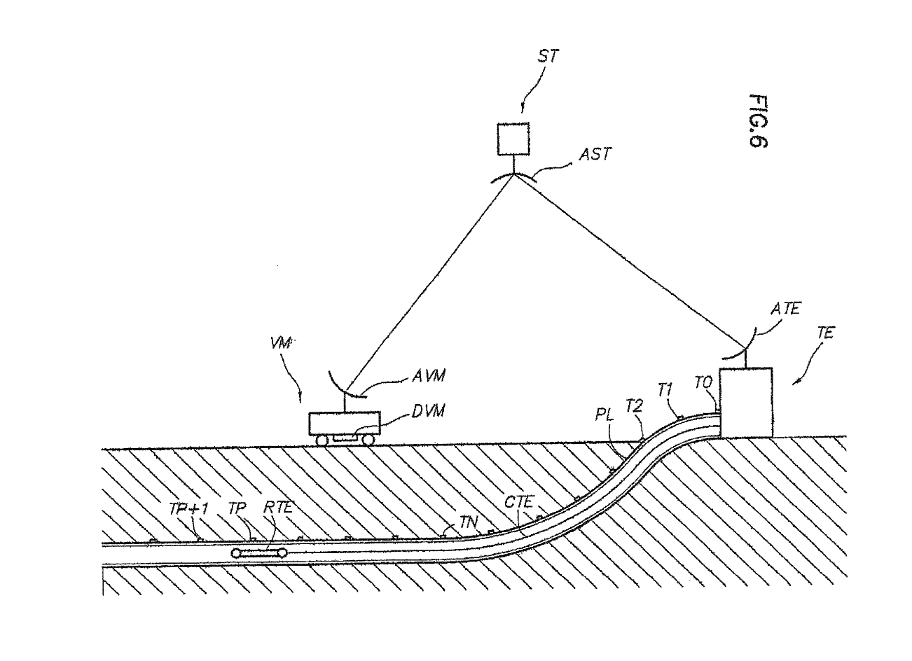

FIG. 6 illustrates a simplified diagram of a system for inspecting a buried pipeline.

In the example illustrated in FIG. 1, the method for localizing anomalies located inside a hollow structure laid on bare ground and/or buried, comprises the following steps:
defining the mark of the origin (block 1) so that the same origin may be assigned for the phases of internal observation of the structure and of external localization of a possible anomaly in said structure,
internally observing the structure and counting the marks (block 2),
testing for the presence of anomaly (block 3):
   no anomaly: test whether path was covered (block 4); if “yes”, end of the localization method; if “no”, continuation of the method and return (block 2),
   presence of an anomaly: next step.
positioning the observed anomaly (block 5):
   either in the vicinity of a mark N,
   or between marks N and N+1,
storing in memory the marks associated with the observed anomalies (block 6),
testing whether path was covered (block 7): if “yes”, end of the localization method; if “no”, continuation of the method and return (block 2).

As defined earlier, said marks accessible from the inside and from the outside are in this case welds connecting the sections of the pipeline. Moreover, in proximity to the n welds (n being equal to or larger than 1), transponders are mechanically firmly attached to the external casing of the pipeline.

This casing made in concrete provides protection to the metal sections; two cases may occur:
the pipeline is buried and the firm attachment of the transponder should be carried out in situ,
the pipeline is being laid and the firm attachment of the transponder may be carried out during the concrete layer coating operation.

In the example illustrated in FIG. 2, the pipeline, illustrated as a section, consists of a metal casing 4 covered with a concrete coating 3; the whole rests on the ground 5.

The positioning of the transponder may be carried out in situ.

The transponder 1 is firmly attached to an open collar 2, made in a flexible and permanent material; said collar, because of its elasticity, allows the transponder 1 to be positioned in the vicinity of the weld connecting two sections forming the metal casing 4.

Moreover, the transponder 1 will be positioned in the vicinity of the upper generatrix of the pipeline, so as to facilitate reading of the identification code of the transponder and therefore of the corresponding weld.

In the example illustrated in FIG. 3, the pipeline, illustrated as a section, consists of a metal casing 4 covered with a concrete coating 3; the whole is buried into the ground 5; completion of the concrete coating was nevertheless carried out by the pipeline-laying equipment beforehand.

In this case, the transponder 1 comprises a sealing member 2 so as to firmly attach the transponder to the pipeline during setting of the coating concrete.

In the example illustrated in FIG. 4, the architecture of a transponder essentially comprises:
a processor 1, intended for managing the peripherals, i.e.:
a ROM memory 2, intended to contain the instructions of the operating system,
a RAM memory 3, intended to temporarily store the data during reading and writing operations,
an EEPROM type memory 4, intended for writing and reading identification data,
an HF transceiver interface 5,
an antenna 6.

The transponders used according to the invention may preferably be of the passive type; indeed, active transponders are powered by an electric power supply and therefore have limited self-sufficiency.

In the case of passive transponders, the electromagnetic energy emitted by the reading and writing device induces at the antenna of the transponder, electrical energy for powering the different members of the transponder.

The authorized frequencies for operating the transponders are the following: 125 kHz, 13.56 MHz, 2.45 GHz, as well as the 860-926 MHz, and 433 MHz band.

In the present case, considering that the transponder is buried in a solid medium, the carrier frequency will be less than 125 kHz; the transmission power of the reading and writing device will be close to or larger than 4 W; with these characteristics, it is thereby possible to read the transponder from a distance close to 100 cm, and to write data into the memory of the transponder while being close to the latter.

In the example illustrated in FIG. 5, the architecture of a reading and writing device essentially comprises:
a central unit 1,
a viewing screen 2,
a writing keyboard 3,
an HF power transmitter 4,
a large gain HF receiver 5,
a duplexer 6,
an antenna 7,
an external link interface 8.

These various components are powered by a self-sufficient electric battery not shown.

Thus, it may be considered that components 4, 5, 6, 7 form the “transmitter” portion, and components 1, 2, 3, 8 form the “reading/writing” portion.

With the interface 8, it is possible to communicate with a management centre responsible for conducting maintenance operations.

In the example illustrated in FIG. 6, the different actors responsible for the maintenance of buried pipelines are illustrated.

The scale of certain actors is not observed, with the purpose of facilitating the description of the schematic structure of a system for inspecting a pipeline.

A pipeline PL is buried in proximity to a terminal TE; with the latter, the inside of the pipeline may notably be accessed in order to carry out the maintenance.

In the present case, an observation and possibly radiographic robot R_{TE} for example of the ROV (Remotely Operated Vehicle) type, follows the inside of the pipeline while being connected via an umbilical cord C_{TE} to the station for monitoring and controlling the robot R_{TE} located in the terminal TE; the umbilical cord C_{TE} notably comprises an electric power supply circuit, the remote control link, as well as the video link associated with an on-board camera.

A plurality of transponders T₀, T₁, T₂, . . . T_{N}, . . . T_{P}, T_{P+1}, . . . are positioned on the casing of the pipeline PL, in proximity to the corresponding welds connecting the metal sections.

A maintenance vehicle VM moving above the pipeline comprises in the vicinity of the ground, a writing and reading device D_{VM}.

A radiofrequency link connects the maintenance vehicle VM and the terminal TE via a telecommunications satellite ST and their respective antennas A_{VM}, A_{TE}, A_{ST}.

Thus, by deploying these means, it becomes possible to intervene in real time on a buried pipeline following the detection of an anomaly observed inside the pipeline.

The whole of the collected information will be stored on board the management centre of the maintenance vehicle VM.

Moreover, the maintenance vehicle VM, via the writing and reading device D_{VM}, may write into the different transponders, information consecutive to the maintenance operation, i.e.:
the customer reference,
the geographical reference: longitude, latitude, burying depth,
the pipeline's reference: laying date, weld no., . . . .
the reference of the intervention: name of the intervening person, date, . . . .
   and transmit to the management centre, the intervention data (date, time, intervening person, references of the read transponders, . . . ), and other relevant data.

As such, by mapping, it will be possible to view on a computer screen, the localization of the pipelines and to display the relevant information. By means of a known method with successive zooms, the centre for managing intervention data will have access to the whole of the information relating to the number of pipelines at a regional level, then at the area level, and then at the immediate proximity level, and finally at the pipeline level illustrated by a section and the corresponding transponders, each of said transponders being associated with a table containing information written into the memory of the transponder.

Thus, the method according to the invention for localizing anomalies located inside and/or outside a hollow structure laid on bare ground and/or buried, allows maintenance operations to be carried out in response to the striven goals, i.e.:
a quasi zero risk of errors,
reduced intervention times and therefore reduced immobilization costs and operating losses.

Moreover, the utilization of transponders set up in situ, provides better knowledge on the maintenance conditions and on the enrichment of data bases guaranteeing a better quality of the maintenance operations.

1. A method for externally localizing anomalies located in a hollow structure laid on bare ground and/or buried, which anomalies have already been detected beforehand by a device moving inside said hollow structure, and positioned by counting, from an origin, marks located at regular intervals, accessible from the inside and from the outside of said hollow structure,
said method consisting of:
a. defining by counting from the same aforesaid origin, a mark accessible from the outside of the hollow structure,
b. positioning a transponder module on the aforesaid mark,
c. identifying the transponder module by an identification code,
d. determining the number of marks separating said anomalies and said identified transponder module.

2. The method according to claim 1, wherein the hollow structure is a pipeline laid on bare ground and/or buried.

3. The method according to claim 1, wherein the marks located at regular intervals accessible from the inside and from the outside of said hollow structure are welds connecting the metal sections forming the casing of the hollow structure.

4. The method according to claim 1, wherein a transponder is localized in proximity to a aforesaid weld.

5. The method according to claim 1, wherein the identification of the transponder module by an identification code is carried out via a reading and writing device.

6. The method according to claim 5, wherein the identification of the transponder module by an identification code is carried out at a frequency equal to 125 kHz or equal to 134.2 kHz and with a power between 1 W and 100 W, preferably between 4 W and 20 W.

7. The method according to claim 5, wherein the identification of the transponder module by an identification code is carried at a frequency less than 125 kHz and with a power between 1 W and 100 W, preferably between 4 W and 20 W.

8. The method according to claim 5, wherein the reading and writing device comprises memory storage means and remote transmission means.

9. A device for applying the method according to claim 1, intended for externally localizing anomalies located in a hollow structure laid on bare ground and/or buried, which anomalies have been detected beforehand by a device moving inside said hollow structure, and positioned by counting from an origin, marks located at regular intervals, accessible from the inside and from the outside of said hollow structure, said device comprising:
a. means for defining by counting, from the same aforesaid origin, a mark accessible from the outside of the hollow structure,
b. means for positioning a transponder module on the aforesaid mark,
c. means for identifying the transponder module by an identification code,
d. means for determining the number of marks separating said anomalies and said identified transponder module.

10. The device according to claim 9, wherein the means for positioning the transponder module on the aforesaid mark comprises an open collar made in a flexible and permanent material.

11. The device according to claim 9, wherein the means for positioning the transponder module on the aforesaid mark comprise a strap made in a flexible and permanent material.

12. The device according to claim 9, wherein the means for positioning the transponder module on the aforesaid mark consist in adhesive bonding.

13. The device according to claim 9, wherein the means for positioning the transponder module on the aforesaid mark comprise a sealing member in the coating concrete or resin of said hollow structure.

14. The device according to claim 9, wherein the means for identifying the transponder module by an identification code comprise a reading and writing device.

15. The device according to claim 14, wherein the aforesaid reading and writing device may write initial data into the transponder module before burial.

16. The device according to claim 9, wherein the hollow structure s a flexible or rigid pipeline laid on bare ground or buried.
